(19) United States
(12) Patent Application Publication
(10) Pub. No.: US 2009/0024990 A1
(43) Pub. Date: Jan. 22, 2009

(54) Security Vulnerability Monitor

(75) Inventors: Navjot Singh, Denville, NJ (US); Timothy Kohchih Tsai, Alviso, CA (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/241,595

(22) Filed: Sep. 30, 2008

Related U.S. Application Data
(62) Division of application No. 10/611,264, filed on Jul. 1, 2003.

(51) Int. Cl. G06F 9/445; G06F 7/06; G06F 17/30

(52) U.S. Cl. 717/168; 707/3; 707/E17.014

(57) ABSTRACT

A method and apparatus for automatically determining whether a security vulnerability alert is relevant to a device (e.g., personal computer, server, personal digital assistant [PDA], etc.), and automatically retrieving the associated software patches for relevant alerts, are disclosed. The illustrative embodiment intelligently determines whether the software application specified by a security vulnerability alert is resident on the device, whether the version of the software application on the device matches that of the security vulnerability alert, and whether the device's hardware platform and operating system match those of the security vulnerability alert.

### CROSS-REFERENCE TO RELATED APPLICATIONS

The application is a divisional of U.S. patent application Ser. No. 10/611,264, filed Jul. 1, 2003, which is currently pending.

### FIELD OF THE INVENTION

The present invention relates to computer security in general, and, more particularly, to techniques for handling security vulnerability alerts.

### BACKGROUND OF THE INVENTION

When a security vulnerability is discovered for a computer software application, a security vulnerability alert is typically issued to notify users of the problem. A security vulnerability alert typically identifies:

the name of the application (e.g., “Microsoft Internet Explorer, etc.),

the pertinent version of the application (e.g., version 5.3, etc.),

the pertinent hardware platform (e.g., Intel x86, etc.),

the pertinent operating system (e.g., Windows ME, etc.), and

a software patch for fixing the security vulnerability.

Three basic techniques exist in the prior art for discovering and handling security vulnerabilities. In the first technique, a user manually discovers the existence of a security vulnerability alert by consulting a web site devoted to security vulnerabilities (e.g., academic websites such as Carnegie Mellon University's CERT, government websites such as the National Institute of Standards and Technology's CSRC, etc.), word of mouth, email, etc. The user then determines whether the alert is relevant to a particular computing device (i.e., whether the operating system and platform of the device match those of the alert, and whether the specified version of the software application is resident on the device). If the alert is relevant, the user downloads the software patch specified in the alert and installs the patch on the device.

In the second technique, an operating system (e.g., Windows XP, etc.) or a software application that runs continuously in the background on a device (e.g., Norton Antivirus, etc.) automatically checks, via the Internet, for software updates (e.g., security vulnerability patches, new virus definitions, etc.) periodically. The software application or operating system typically notifies the user when an update is available, and asks the user whether he or she would like to download and install the update.

In the third technique, a program called a security audit tool executes scripts designed to test whether software resident on the device is susceptible to particular security vulnerabilities, and reports those vulnerabilities to the user. If any security vulnerabilities are found, the user can then download and install the appropriate patch(es). The security audit tool can execute continuously in the background, as in the second technique, or can be invoked manually by a user when desired.

### SUMMARY OF THE INVENTION

The present invention determines automatically whether a security vulnerability alert is relevant to a device (e.g., personal computer, server, personal digital assistant [PDA], etc.), and, when necessary, automatically retrieves the appropriate software patch to be installed on the device. In particular, the illustrative embodiment intelligently determines whether the software application specified by a security vulnerability alert is resident on the device, whether the version of the software application on the device matches that of the security vulnerability alert, and whether the device's hardware platform and operating system match those of the security vulnerability alert. If all criteria match, the illustrative embodiment automatically downloads the appropriate software patch. In some embodiments, the patch is automatically installed on the device after it is retrieved, while in some other embodiments, the user can install the patch manually when he or she wishes.

A software application can be described by a tuple comprising: (i) an application identifier, (ii) a version number, (iii) an operating system, and (iv) a hardware platform. For the purposes of this specification, the term “software application” and its inflected forms are defined as a program that corresponds to exactly one such tuple. For example, “Oracle 8.1 for Solaris on x86,” “Oracle 9.0 for Linux on x86,” and “Internet Explorer 5.3 for Windows NT 4.0 on Alpha” are examples of three different software applications. In accordance with current terminology, the term “application” is also employed in this specification as shorthand for “software application.”

The illustrative embodiment of the present invention determines whether a software application is resident on a device by any of the following three methods: consulting a software installation manager (SIM), if the device's operating system has one; consulting a registry, if the device's operating system has one; and searching the device's file system.

The illustrative embodiment comprises: receiving a security vulnerability alert associated with a software application; and determining whether the software application is resident on a device.

### BRIEF DESCRIPTION OF THE DRAWINGS

FIG. 1 depicts a block diagram of the salient components of an apparatus for performing the methods depicted in FIGS. 4, 5, and 6, in accordance with the illustrative embodiment of the present invention.

FIG. 2 depicts a block diagram of the salient components of memory 120, as shown in FIG. 1, in accordance with the illustrative embodiment of the present invention.

FIG. 3 depicts a block diagram of the salient components of operating system 210, as shown in FIG. 2, in accordance with the illustrative embodiment of the present invention.

FIG. 4 depicts a flowchart of a method for automatically handling security vulnerability alerts, in accordance with the illustrative embodiment of the present invention.

FIG. 5 depicts a flowchart of a method for installing a software application on a device, in accordance with the illustrative embodiment of the present invention.

FIG. 6 depicts a flowchart of a method for automatically ascertaining what software applications are resident on a device and fixing any known security vulnerabilities, in accordance with the illustrative embodiment of the present invention.

### DETAILED DESCRIPTION

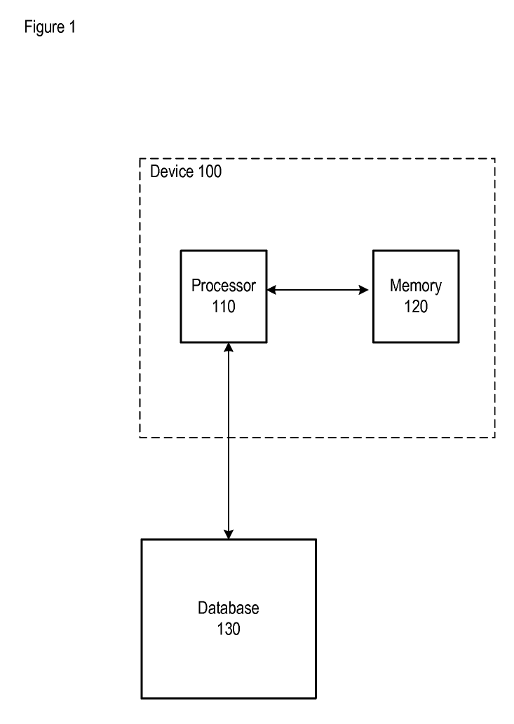

FIG. 1 depicts a block diagram of the salient components of device 100. As depicted in FIG. 1, device 100 comprises processor 110 and memory 120, interconnected as shown. FIG. 1 also depicts database 130, which is external to device 100.

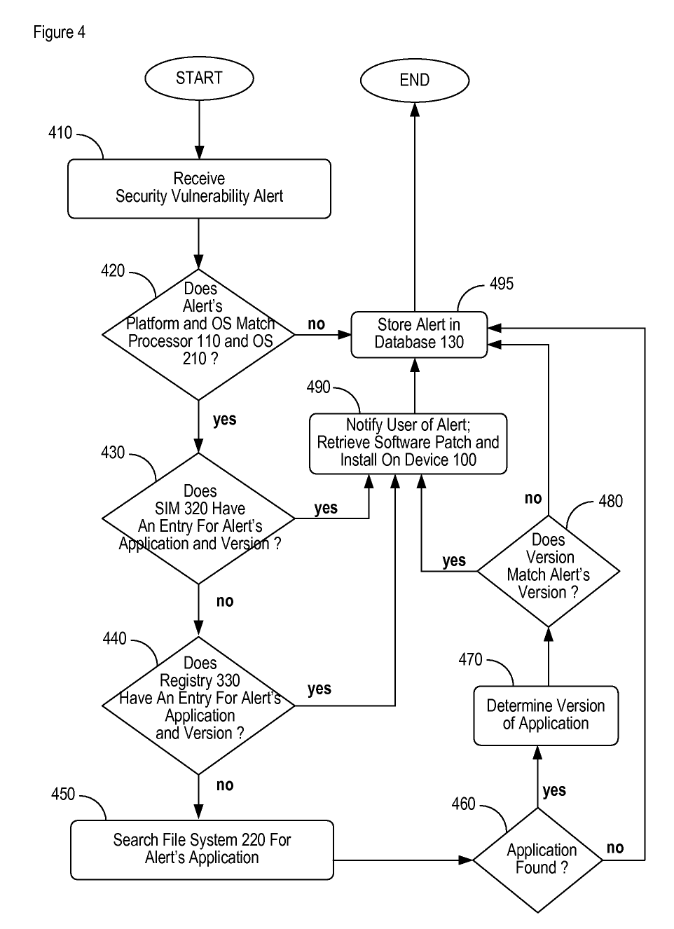

Processor 110 is a general-purpose processor that is capable of executing instructions stored in memory 120, of reading data from and writing data into memory 120, of submitting queries to and receiving query results from database 130, and of executing the tasks described below and with respect to FIGS. 4, 5, and 6. In some alternative embodiments of the present invention, processor 110 is a special-purpose processor. In either case, it will be clear to those skilled in the art, after reading this disclosure, how to make and use processor 110.

Memory 120 stores data and executable instructions, as is well-known in the art, and might be any combination of random-access memory (RAM), flash memory, disk drive, etc.

Database 130 stores security vulnerability alerts and enables efficient querying of these alerts. As is well-known in the art, database 130 could be a relational database, an object-oriented database, a collection of “flat files”, etc. It will be appreciated by those skilled in the art that although in the illustrative embodiment database 130 is shown to be external to device 100 (i.e., a “remote” database), in some embodiments database 130 might be internal to device 100 (i.e., stored in memory 120). In either case, it will be clear to those skilled in the art, after reading this disclosure, how to make and use database 130.

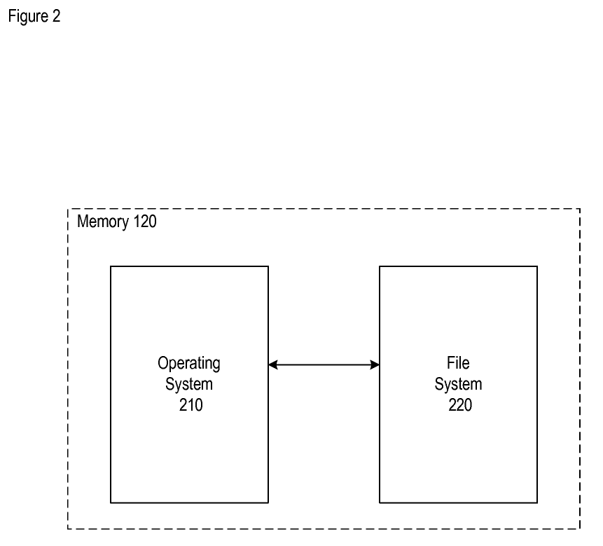

FIG. 2 depicts a block diagram of the salient components of memory 120, as shown in FIG. 1, in accordance with the illustrative embodiment of the present invention. As depicted in FIG. 2, memory 120 comprises operating system 210 and file system 220, interconnected as shown.

Operating system 210 is a program that acts as an intermediary between a user of device 100 and device 100's hardware (e.g., processor 110, memory 120, etc.), as is well-known in the art.

File system 220 organizes information into logical storage units called files that are mapped by operating system 210 on to physical memory 120, as is well-known in the art.

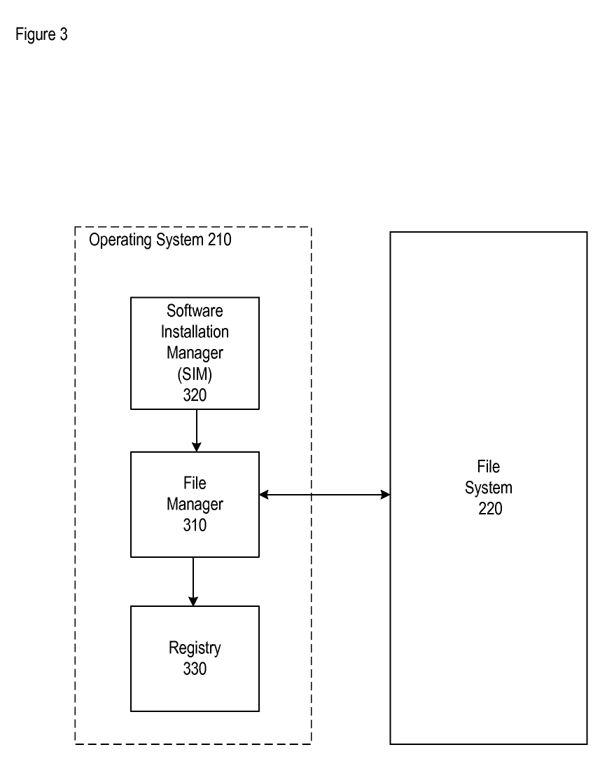

FIG. 3 depicts a block diagram of the salient components of operating system 210 in accordance with the illustrative embodiment of the present invention. As shown in FIG. 3, operating system 210 comprises file manager 310, software installation manager (SIM) 320, and registry 330, interconnected as shown.

File manager 310 is responsible for a variety of tasks concerning file system 220, including the creation and deletion of files in file system 220, the creation and deletion of directories in file system 220, the mapping of files in file system 220 on to secondary storage, etc., as is well-known in the art.

Software installation manager (SIM) 320 is responsible for installing and uninstalling software applications on device 100, and is aware of the applications that are currently installed on device 100, as is well-known in the art. As shown in FIG. 3, software installation manager writes to file system 220 via file manager 310 when installing and uninstalling applications. Commercial software installation managers include Red Hat Linux Package Manager, Microsoft Windows Software Installation Manager, Palm Install Tool Plus, etc.

Registry 330 stores system configuration information about device 100 (e.g., what hardware is attached to device 100, what system options have been selected, how computer memory 120 is organized, what software applications are to be present when the operating system is started, what applications are installed on device 100, etc.), as well as user-specific information and settings (e.g., profiles, desktop preferences, etc.) When applications are installed or uninstalled, software installation manager 320 updates registry 330 accordingly via file manager 310. As is well understood in the art, data in the registry is typically accessed via a single application programming interface (API). Registries are typically found in Microsoft Windows operating systems (e.g., Windows XP, Windows 2000, etc.). Other operating systems (e.g., Red Hat Linux, Solaris, etc.) typically have similar repositories for storing system configuration and user-specific information; however, these repositories might not include information about installed applications.

FIG. 4 depicts a flowchart of a method for automatically handling security vulnerability alerts, in accordance with the illustrative embodiment of the present invention. It will be clear to those skilled in the art that the method of FIG. 4 can be performed by device 100 itself, or by some other device. In addition, it will be clear to those skilled in the art which tasks depicted in FIG. 4 can be performed simultaneously or in a different order than that depicted.

At task 410, a security vulnerability alert is received. As will be appreciated by those skilled in the art, a security vulnerability alert might be received in a variety of ways via “push” (e.g., an incoming message, a database trigger, etc.) or via “pull” (e.g., a database query, an intelligent web agent [also known as a “spider” or “bot”] that searches websites for new alerts, etc.).

At task 420, the hardware platform and operating system specified in the security vulnerability alert are compared to those of device 100 (i.e., processor 110 and operating system 210). If both match, execution proceeds to task 430, otherwise execution continues at task 495.

At task 430, software installation manager (SIM) 320 is consulted to determine if there is an entry for the application name and version specified in the security vulnerability alert. If such an entry is found, execution proceeds to task 490, otherwise execution continues at task 440.

At task 440, a lookup of registry 330 is performed to determine if there is an entry for the application name and version specified in the security vulnerability alert. If such an entry is found, execution proceeds to task 490, otherwise execution continues at task 450.

At task 450, file system 220 is searched in well-known fashion (e.g., breadth-first search, depth-first search, etc.) for the filename(s) of executable(s) associated with the application. The filenames are typically specified in the security vulnerability alert, or might also be obtained from a software installation package for the application, a database (e.g., database 130, etc.) that maps applications to filenames, etc.

In some embodiments, the entire file system might be searched, while in some other embodiments, a heuristic might be employed to search certain portions of the file system where the software application would most likely reside. For example, in a Linux file system, directories “/bin,” “/usr/bin,” “/usr/local/bin,” “/tmp,” “/var/tmp”, and the home directories of each user might be searched. In a Windows file system, a search of directory “\Program Files,” and perhaps a breadth-first search of the root directory “\” up to depth 2, if necessary, might be performed. (The latter search is motivated by the observation that some applications specify a default directory of the form “C:\appname” at installation time, and that typically the executable is at the top level of this directory.) As will be understood by those skilled in the art, task 450 could take advantage of an indexed database of specific directories (e.g., “fast find” database in Microsoft Windows, “locate” database in Linux, etc.), if such a database exists, to improve performance.

Task 460 checks whether the executable filename(s) was (were) found in task 450; if so, execution proceeds to task 470, otherwise execution continues at task 495.

At task 470, the version of the software application found on file system 220 is determined. As will be clear to those skilled in the art, a number of different methods could be employed to determine the version: checking the executable filename (e.g., “oracle81.exe” for Oracle 8.1, etc.), running the executable in a “sandbox” environment with the appropriate command-line arguments (e.g., “appname—version,” etc.), performing a text-based (e.g., ASCII, etc.) scan of the executable, etc.

Task 480 checks whether the version of the application on device 100, determined at task 470, matches that of the security vulnerability alert; if so, execution proceeds to task 490, otherwise execution continues at task 495. As is well-known in the art, a security vulnerability alert might specify a single version (e.g., 2.4, etc.), a range of versions (e.g., “2.4-2.7”, etc.), an “open” range (e.g., “<=2.4” to indicate all versions up to and including 2.4, “>=2.4” to indicate all versions since version 2.4, etc.), etc.

At task 490, the user is notified of the security vulnerability alert (e.g., a pop-up window, an email, etc.), and then the software patch is retrieved (e.g., downloaded from a website specified in the security vulnerability alert, etc.) and installed. In some embodiments, the retrieval and installation of the software patch might be performed automatically, while in some other embodiments, the user might be notified of the existence of the software patch and a location from which the software patch can be obtained for performing these tasks manually. Execution proceeds from task 490 to task 495.

At task 495, the security vulnerability alert received at task 410 is stored in database 130.

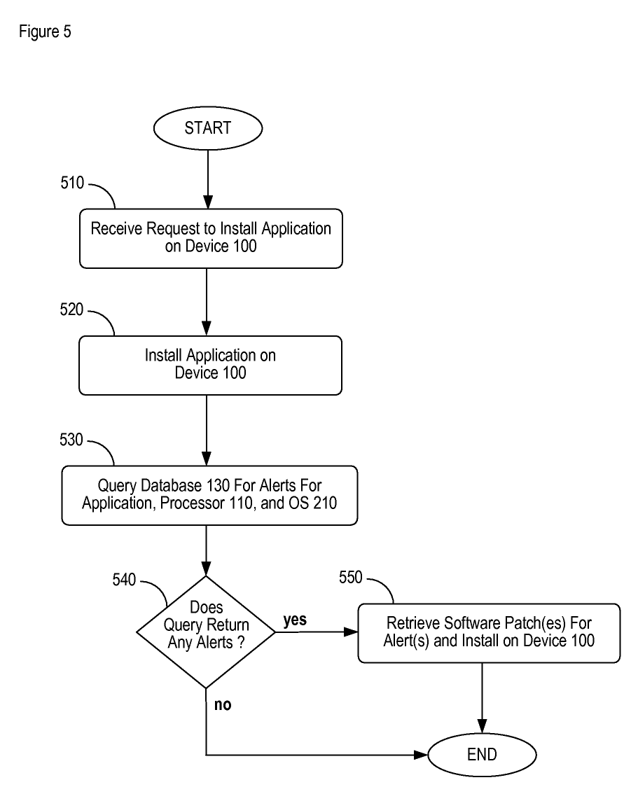

FIG. 5 depicts a flowchart of a method for installing a software application on device 100, in accordance with the illustrative embodiment of the present invention. The method of FIG. 5 checks after installing an application on device 100 whether any relevant security vulnerability alerts for the application exist, and if so, retrieves and installs the associated software patches. It will be clear to those skilled in the art that the method of FIG. 5 can be performed by device 100 itself, or by some other device. In addition, it will be clear to those skilled in the art which tasks depicted in FIG. 5 can be performed simultaneously or in a different order than that depicted.

At task 510, a request to install a software application on device 100 is received.

At task 520, the application is installed on device 100.

At task 530, database 130 is queried for any security vulnerability alerts pertaining to the application, processor 110, and operating system 210.

At task 540, the result set of the query submitted at task 530 is checked. If one or more security vulnerability alerts were returned, execution proceeds to task 550, otherwise the method terminates.

At task 550, software patches specified by the security vulnerability alerts returned at task 530 are retrieved and installed on device 100. As in task 490, in some embodiments the retrieval and installation of the software patches might be performed automatically, while in some other embodiments, the user might be given the appropriate information to perform these tasks manually.

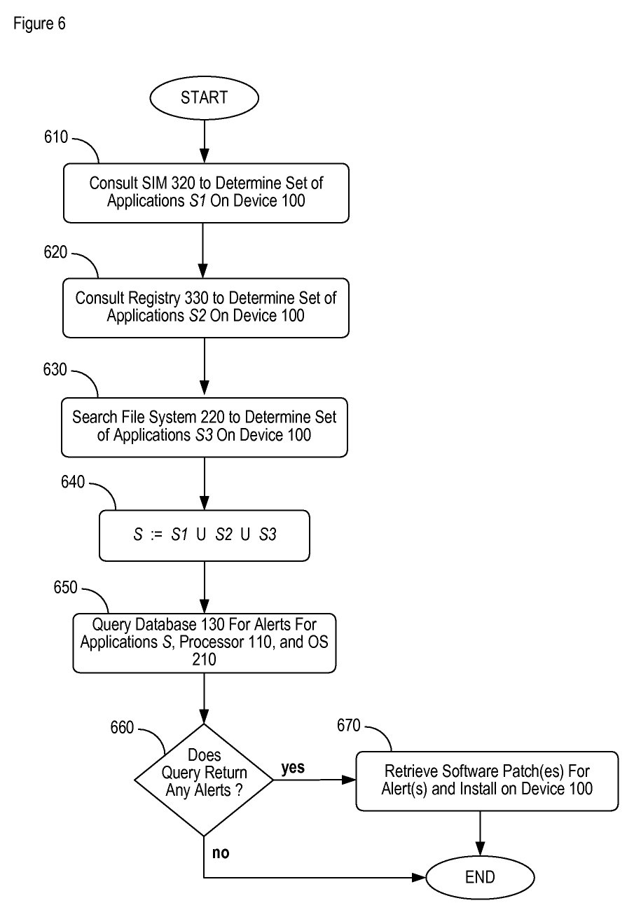

FIG. 6 depicts a flowchart of a method for automatically ascertaining what software applications are resident on device 100 and fixing any known security vulnerabilities, in accordance with the illustrative embodiment of the present invention. The method of FIG. 6 thus performs an “initial scrub” of a device 100 (e.g., for a device that is introduced into a secure environment, etc.). It will be clear to those skilled in the art that the method of FIG. 6 can be performed by device 100 itself, or by some other device. In addition, it will be clear to those skilled in the art which tasks depicted in FIG. 6 can be performed simultaneously or in a different order than that depicted.

At task 610, software installation manager 610 is consulted to determine a set S1 of applications resident on device 100.

At task 620, registry 330 is consulted to determine a set S2 of applications resident on device 100.

At task 630, file system 220 is searched as described in task 450 to determine a set S3 of applications resident on device 100. The respective versions of each software application found on file system 220 can be determined as described in task 470.

At task 640, a set S is computed as the union of sets S1, S2, and S3. S thus represents the set of all applications resident on device 100 that were ascertained at tasks 610, 620, and 630.

At task 650, database 130 is queried for any security vulnerability alerts pertaining to the applications of set S, processor 110, and operating system 210.

At task 660, the result set of the query submitted at task 650 is checked. If one or more security vulnerability alerts were returned, execution proceeds to task 670, otherwise the method terminates.

At task 670, software patches specified by the security vulnerability alerts returned at task 650 are retrieved and installed on device 100. As in tasks 490 and 550, in some embodiments the retrieval and installation of the software patches might be performed automatically, while in some other embodiments, the user might be given the appropriate information to perform these tasks manually.

As will be appreciated by those skilled in the art, in a network comprising several devices (e.g., a local-area network of personal computers, etc.), it might be advantageous in some embodiments to employ a centralized proxy architecture in which a single device gathers security vulnerability alerts and software patches for all the devices in the network, and in which devices in the network obtain security vulnerability alerts and software patches from the proxy. It will be clear to those skilled in the art how to make and use embodiments of the present invention that employ such a proxy architecture.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
(a) ascertaining what software applications are resident on a device; and
(b) querying a database for security vulnerability alerts for said software applications.

2. The method of claim 1 further comprising installing a software patch when (b) returns a security vulnerability alert.

3. The method of claim 2 further comprising retrieving said software patch.

4. The method of claim 1 wherein (a) comprises consulting a software installation manager for said device.

5. The method of claim 1 wherein (a) comprises consulting a registry for said device.

6. The method of claim 1 wherein (a) comprises searching a file system of said device.
